(19) United States
(12) Patent Application Publication
(10) Pub. No.: US 2005/0004799 A1
(43) Pub. Date: Jan. 6, 2005

(54) System and method for a spoken language interface to a large database of changing records

(76) Inventor: Yevgenly Lyudovyk, Old Bridge, NJ (US)

Correspondence Address: KENYON & KENYON, 1500 K STREET, N.W., SUITE 700, WASHINGTON, DC, 20005, US

(21) Appl. No.: 10/840,377

(22) Filed: May 7, 2004

Related U.S. Application Data
(63) Continuation-in-part of application No. 10/331,343, filed on Dec. 31, 2002.

(51) Int. Cl. G10L 15/00

(52) U.S. Cl. 704/254

(57) ABSTRACT

Embodiments of the present invention provide a spoken language interface to an information database. A plurality of word N-grams from each entry in the information database may be generated. A corresponding probability score for each word N-gram included in the plurality of word N-grams may also be generated. Any one word N-gram from the plurality of word N-grams may be included in a distorted version of the entry generated based on a transformation rule. Duplicate word N-grams from the plurality of word N-grams generated from each entry in the information database may be identified. Corresponding probability scores for the identified duplicate word N-grams may be accumulated. One of the duplicate word N-grams and the corresponding accumulated probability score may be stored in a grammars database.

### CROSS-REFERENCE TO RELATED PATENT APPLICATIONS

This patent application is a continuation-in-part (CIP) of pending U.S. patent application Ser. No. 10/331,343, filed Dec. 31, 2002.

### TECHNICAL FIELD

The present invention relates to automatic directory assistance. In particular, the present invention relates to systems and methods for providing a spoken language interface to a dynamic database.

### BACKGROUND OF THE INVENTION

In recent years, automated attendants have become very popular. Many individuals or organizations use automated attendants to automatically provide information to callers and/or to route incoming calls. An example of an automated attendant is an automated directory assistant that automatically provides a telephone number, address, etc. for a business or an individual in response to a user's request.

Typically, a user places a call and reaches an automated directory assistant (e.g. an Interactive Voice Recognition (IVR) system) that prompts the user for desired information and searches an informational database (e.g., a white pages listings database) for the requested information. The user enters the request, for example, a name of a business or individual via a keyboard, keypad or spoken inputs. The automated attendant searches for a match in the informational database based on the user's input and may output a voice synthesized result if a match can be found.

In cases where a very large information database such as the white pages listings database needs to be searched, developers may use statistical grammars such as stochastic language models to efficiently recognize a user's communication and find an accurate result for a request by the user. Using conventional techniques, a large corpus of user utterances, for example, in the context of the underlying application, is collected and transcribed. This corpus is used to estimate parameters for the stochastic language models.

The corpus has to be large enough to sufficiently represent all possible word sequences that a user might utter or input in the context of the application. For an application such as directory assistance, where the users may choose from millions of listing names, and where new listings are being added every day, collection of such corpus can be very difficult.

### SUMMARY OF THE INVENTION

Embodiments of the present invention provide a spoken language interface to an information database. A grammars database based on the entries contained in the information database may be generated. The entries in the grammars database may be a compact representation of the entries in the information database. An index database based on the entries contained in the information database may be generated. The grammars database and the index database may be updated periodically based on updated entries contained in the information database. A recognized result of a user's communication based on the updated grammars database may be generated. The updated index database may be searched for a list of matching entries that match the recognized result. The list of matching entries may be output.

### BRIEF DESCRIPTION OF THE DRAWINGS

Embodiments of the present invention are illustrated by way of example, and not limitation, in the accompanying figures in which like references denote similar elements, and in which:

FIG. 1 is a block diagram of an automated communication processing system in accordance with an embodiment of the present invention;

FIG. 2 illustrates a block diagram in accordance with an embodiment of the present invention;

FIG. 3 illustrates a block diagram in accordance with an embodiment of the present invention;

FIG. 4 is flowchart showing an automated communication processing system in accordance with an exemplary embodiment of the present invention;

FIG. 5 illustrates a block diagram in accordance with an embodiment of the present invention; and

FIG. 6 is flowchart showing an automated communication processing system in accordance with an exemplary embodiment of the present invention.

### DETAILED DESCRIPTION

Embodiments of the present invention relate to a method and apparatus for automatically recognizing and/or processing a user's communication. The invention relates to a method and apparatus for building a system that provides an automatic interface such as an automatic spoken language interface to an information database. This information database may include entries or records that may be changing. Some records may be added while others are deleted, still other records may need updating because the information included in the records has changed.

In embodiments of the present invention, the system may separate the task of speech recognition from an index search task. These tasks may be performed to automatically recognize and/or process the user's communication such as a request for information from the information database. An automated recognition process such as a speech recognition process to recognize the user's communication may use a grammars database. The grammars database may be based on compact representation of entries or records in the index database and/or the information database.

The results of the speech recognition process may be independent from a record or a set of records included in the index database. A separate index search process to search the index database may use the results of the speech recognition process. This technique may be used by the system to process the user's communications such as a request for information. If a match is found, the information may be automatically presented to the user.

In embodiments of the present invention, the grammar database used by the speech recognition process, and/or the index database used by the index search process, may be updated periodically. These databases may be updated based on a dynamic information database such as a listings database. As indicated above, the information database may be in a state of constant flux due to entries that are being constantly added, deleted, updated, etc. Accordingly, the grammar database and/or the index database may be updated periodically to reflect the changes in the information database. Advantageously, an updated grammars database and/or an updated index database may improve the efficiency and/or accuracy of the system.

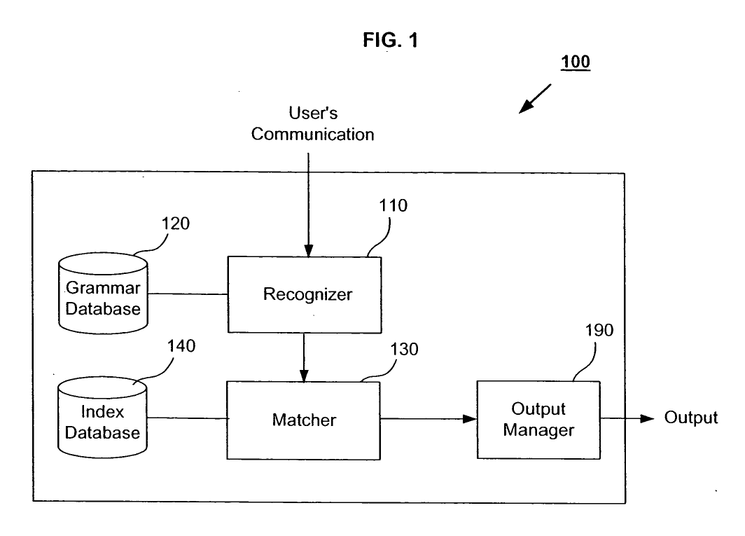

FIG. 1 is an exemplary block diagram of an automated communication processing system 100 for processing a user's communication in accordance with an embodiment of the present invention. A recognizer 110 is coupled to a grammar database 120 and a matcher 130 that is coupled to an index database 140. The matcher may be coupled to an output manager 190 that provides an output from the automated processing system 100.

In embodiments of the present invention, the user's input may be speech input that may be input from a microphone, a wired or wireless telephone, other wireless device, a speech wave file or other speech input device.

While the examples discussed in the embodiments of the patent concern recognition of speech, the recognizer 110 may also receive a user's communication or inputs in the form of speech, text, digital signals, analog signals and/or any other forms of communications or communications signals.

As used herein, user's communication can be a user's input in any form that represents, for example, a single word, multiple words, a single syllable, multiple syllables, a single phoneme and/or multiple phonemes. The user's communication may include a request for information, products, services and/or any other suitable requests.

A user's communication may be input via a communication device such as a wired or wireless phone, a pager, a personal digital assistant, a personal computer, and/or any other device capable of sending and/or receiving communications. In embodiments of the present invention, the user's communication could be a search request to search the World Wide Web (WWW), a Local Area Network (LAN), and/or any other private or public network for the desired information.

In embodiments of the present invention, the recognizer 110 may be any type of recognizer known to those skilled in the art. In one embodiment, the recognizer may be an automated speech recognizer (ASR) such as the type developed by Nuance Communications. The communication processing system 100, where the recognizer 110 is an ASR, may operate similar to an IVR but includes the advantages of an grammars database 120 and/or index database 140 that may be periodically updated in accordance with embodiments of the present invention.

In alternative embodiments of the present invention, the recognizer 110 can be a text recognizer, optical character recognizer and/or another type of recognizer or device that recognizes and/or processes a user's inputs, and/or a device that receives a user's input, for example, a keyboard or a keypad. In embodiments of the present invention, the recognizer 110 may be incorporated within a personal computer, a telephone switch or telephone interface, and/or an Internet, Intranet and/or other type of server.

In an alternative embodiment of the present invention, the recognizer 110 may include and/or may operate in conjunction with, for example, an Internet search engine that receives text, speech, etc. from an Internet user. In this case, the recognizer 110 may receive user's communication via an Internet connection and operate in accordance with embodiments of the invention as described herein.

In one embodiment of the present invention, the recognizer 110 receives the user's communication and generates a recognized result that may include a list of recognized entries, using known methods. The recognition of the user's input may be carried out using a grammar database 120.

As an example, the grammar database 120 may be a statistical N-gram grammar such as a uni-gram grammar, bi-gram grammar, tri-gram grammar, etc. The initial grammar 120 may be word-based grammar, subword-based grammar, phoneme-based grammar, or grammar based on other types of symbol strings and/or any combination thereof.

In embodiments of the present invention, the grammar database 120 may be extracted from and/or created based on an information database such as a listings database that may include residential, governmental, and/or business listings for a particular town, city, state, and/or country. In accordance with embodiments of the present invention the grammar database 120 may be created and/or periodically updated using a distortion module (to be discussed below in more detail).

In embodiments of the present invention, the index database 140 may include a database look-up table for a larger informational database such as a listings database. The index database 140 may include, for example, listing entries such as a name of a business or individual. Each entry may include a record identifier (record ID) that indicates the location of additional information, in an underlying listings database, associated with the listing entry. Thus, the index database 140 may include an index for the larger listings or information database.

In embodiments of the present invention, a user's communication may be received by recognizer 110. The recognizer may generate a recognition result using the grammar database 120. The recognition result may include a list of N-best recognized entries where, where N may be may be a pre-defined integer such as 1, 2, 3 . . . 100, etc. The recognition result may be a hypothesis of the user's input as recognized by the recognizer 110.

In embodiments of the present invention, each entry in the list of recognized entries generated by the recognizer 110 may be ranked with an associated first confidence score. The confidence score may indicate the level of confidence or likelihood of the hypothesis that this recognized entry is what was uttered (input) by the user. A higher first confidence score associated with a recognized entry may indicate a higher likelihood of the hypothesis that this recognized entry is what was uttered (input) by the user.

In embodiments of the preset invention, the list of recognized entries may be input to a matcher 130. The matcher 130 may search index database 140 for a list of matching listing entries. The list of matching entries along with record IDs associated with each entry may be output by the matcher 130. The record ID may be used to access the additional information from the listings database. The system 100 may access such additional information for each entry in the list of matching entry, or alternatively, the system may use a dialog with a user to confirm the listing, from the list, for which the user desires additional information before accessing the additional information. Such dialog and/or further processing may be conducted using output manager 190.

In embodiments of the invention, the dialog manager 190 may request the user to specify which information is requested for the listing. For example, once the user confirms the listing from the list of matched entries, the output manager 190, may request the user to indicate whether, for example, an address and or a phone number for the confirmed listing is requested. The requested information may be retrieved from the listings database and efficiently provided to the user. It is recognized that the index database 140 may include the additional information so that there may be no need to access the listings database for such information such as an address, phone number, e-mail address, etc. for each listing or entry.

It is recognized that the stored entries in the index database 140 or other informational database could represent or include a myriad of other types of information such as individual directory information, specific business or vendor information, postal addresses, e-mail addresses, etc. Such databases may include residential, governmental, and/or business listings for a particular town, city, state, and/or country.

In embodiments of the present invention, the database 140 can be part of larger database of listings information such as a database or other information resource that may be searched by, for example, any Internet search engine when performing a user's search request.

In embodiments of the present invention, a first confidence score may be generated for each entry in the recognition results by the speech recognizer. This technique may be used to limit the number of entries in the list of recognized entries to N-best entries based on a recognition confidence threshold (e.g., THR1). For example, the recognizer 110 may be set with a minimum recognition threshold. Entries having a corresponding first confidence score equal to and/or above the minimum recognition threshold may be included in the list of recognized N-best entries.

In embodiments of the present invention, entries having a corresponding first confidence score less than the minimum recognition threshold may be omitted from the list. The recognizer 110 may generate the first confidence score, represented by any appropriate number, as the user's communication is being recognized. The recognition threshold may be any appropriate number that is set automatically or manually, and may be adjustable, based on, for example, on the top-best confidence scores. It is recognized that other techniques may be used to select the N-best results or entries.

In embodiments of the present invention, the entries in the recognized list of entries may be a sequence of words, sub-words, phonemes, or other types of symbol strings and/or combination thereof.

Each entry in the recognized list of entries may be text or character strings that represent a hypothesis of what the user said in response to a question like “What listing please?” In one example, a recognized entry may be the name of a business for which the user desires a telephone number. Each entry included in the list of entries generated by the recognizer 110 may be a hypothesis of what was originally input by the user.

In embodiments of the present invention, as indicated above, the recognized list of entries generated by the recognizer by the recognizer 110 may be input to matcher 130. The matcher 130 may receive the N-best recognition results with corresponding first confidence scores and may search database 140. The matcher 130 may generate a list of one or more matching entries. The list of matching entries may represent, for example, what the caller had in mind when the caller inputs the communication into recognizer 110.

The matching algorithm employed by matcher 130 may be based on words, sub-word, phonemes, characters or other types of symbol strings and/or any combination thereof. For example, matcher 130 can be based on N-grams of words, characters or phonemes.

In embodiments of the present invention, the list of matching entries generated by the matcher 130 may be a list of M-best matching entries, where M may be may be a pre-defined integer such as 1, 2, 3 . . . 100, etc. Alternatively, each entry in the list of matching entries generated by the matcher 130 may be ranked with an associated second confidence score. The second confidence score may indicate the level of confidence (or likelihood) that a particular matching entry is the entry in database 140 that the user had in mind when she uttered the utterance. A higher second confidence score associated with a matching entry may indicate a higher level of likelihood that this particular matching entry is the entry that the user had in mind when she uttered the utterance.

In embodiments of the present invention, the second confidence score may be used to limit the entries in the list of matching entries to M-best entries based on a matching threshold (e.g., THR2). For example, the matcher 130 may be set with a minimum matching threshold. Entries having a corresponding second confidence score equal to and/or above the minimum matching threshold may be included in the list of matching M-best entries.

In embodiments of the present invention, entries having a corresponding second confidence score less than the minimum matching threshold may be omitted from the list. The matcher 130 may generate the confidence score, represented by any appropriate number, as the database 140 is being searched for a match. The matching threshold may be any appropriate number that is set automatically or manually, and may be adjustable based on, for example, on the top-best confidence scores. It is recognized that other techniques may be used to select the M-best entries.

In an exemplary embodiment of the present invention, the matcher 130 may, for example, extract one or more recognized N-grams from each entry in list of recognized entry generated by the recognizer 110. The matcher 130 may search all of the entries in the database 140 to find a match for each of the recognized N-grams. Based on the matched entries, the matcher 130 may generate a list of M-best matching entries including a corresponding second confidence score for each matched entry in the list.

In an embodiment of the present invention, the list of M-best matching entries may be output to a user for presentation and/or confirmation via output manager 190.

In embodiments of the present invention, the matcher 130 may output to the output manager 190 for further processing. For example, depending on the distribution of the various confidence scores associated with each entry in the list of N-best and/or M-best entries, and/or some other parameter, the output manager 190 may automatically route a call and/or present requested information to the user without user intervention.

Depending on the distributions and/or parameters, the output manager 190 may forward the list of N-best and/or M-best matching entries to the user for selection of the desired entry. Based on the user's selection, the output manager 190 may route a call for the user, retrieve and present the requested information, or perform any other function.

In embodiments of the present invention, depending on the same distributions, the output manager 190 may present another prompt to the user, terminate the session if the desired results have been achieved, or perform other steps to output a desired result for the user. If the output manager 190 presents another prompt to the user, for example, asks the user to input the desired listings name once more, another list of M-best matching entries may be generated and may be used to help the output manager 190 to make the final decision about the user's goal.

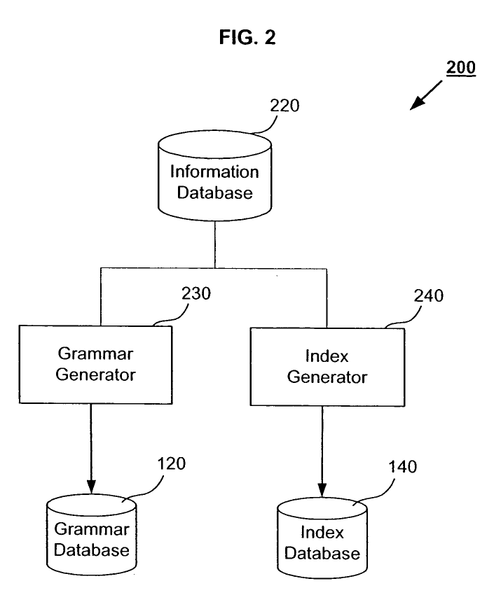

FIG. 2 illustrates a diagram of an off-line processing system 200 in accordance with an embodiment of the present invention. As shown, an information database 220 may be periodically extracted by a grammar generator 230 to generate grammars 120. The information database 220 may also be periodically extracted by index generator 240 to generate index database 140. These databases such as grammar database 120 and/or index database may be employed by the automated communications system 100, in accordance with embodiments of the present invention.

These information database 220 may be extracted periodically based on a predetermined schedule such as once a day, week, etc. Optionally and/or additionally, the database 220 may be extracted based on dynamic criteria such as threshold number of changes made to the database 220. For example, if a threshold number of entries (e.g., 5, 6, 19, 15, etc.) are updated, edited, added, and/or deleted, then such an event may trigger the extraction of database 220 to update grammar data base 120 and/or index database 140.

In embodiments of the present invention, the index generator 240 may update, add, delete, etc. the entry name and/or a corresponding record identifier (record ID) as the information database 220 changes. For example, if a new record is added, then that entry along with the location of the entry (e.g., the record ID) in database 220 may be added to the index database 140 by generator 240. If an entry is deleted in the database 220 and/or the record ID is changed, then the index generator 240 may update the index database 140 to reflect the change.

In embodiments of the present invention, the grammars in database 120 may be computed by estimated N-gram statistics such as bi-gram statistics. It is recognized that other N-gram statistics such as unigram, tri-gram, etc. may be used.

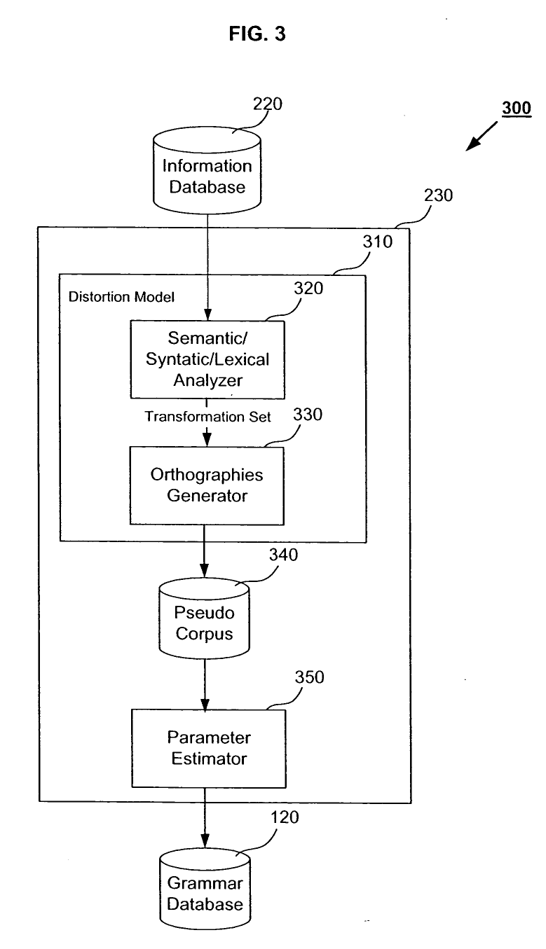

In embodiments of the present invention, the listings database 220 may be extracted by grammar generator 230 to generate grammar database 120, as shown in FIG. 3. FIG. 3 is a detailed block diagram of grammar generator 230 in accordance with embodiments of the present invention.

In accordance with embodiments of the present invention, the entries in listings database 220 may be processed by a distortion module 310. The distortion module 310 may dynamically generate the different ways an entry in the listings database 220 may be input or pronounced by a user. The output of the distortion module 310 may be used to create a pseudo-corpus 340 from which the probabilities needed for stochastic language model may be estimated by the parameter estimator 350. Accordingly, the grammars of database 120 may be dynamically generated and/or updated in accordance with embodiments of the present invention.

In embodiments of the present invention, the distortion module 310 may process each listing of database 220 through a semantic/syntactic/lexical analyzer 320. The analyzer 320 may generate a transformation set that specifies the possible transformation rules to apply to the listing name. For example, the analyzer 320 may generate transformation rules that specify how a user may alter and/or distort a requested listing. For example, these transformation rules may state that any word omission is always possible, but words can change their order (e.g., word inversion) only if the listing name contains words like “and”, “or”, “by”, etc. The rules may also specify appropriate word and/or phrase substitutions. For example, a rule may state that the word “pizzeria” may be substituted with a word “pizza.” The rules contained in the analyzer 320 may also determine the probability for each type of distortion.

It is recognized that the transformation rules described above are given by way of example only, and any number of different types of transformation rules may be used by analyzer 320. In accordance, with embodiments of the present invention, these transformation rules may indicate how a listing may be altered and/or distorted. As indicated above, this altered or distorted listing may indicate how users may alter the listing when requesting information such as directory assistance.

In embodiments of the present invention, the orthographies generator 330 may apply the transformation rules (e.g., included in the transformation set) generated by the analyzer 320 to each listing to generate the listing's orthographies. In embodiments of the present invention, these orthographies may be one or more variation of the listing that may be generated based on the applied rules. These variations may reflect how a user may input the listing.

In embodiments of the present invention, the orthographies generator 330 may output the orthographies and the associated probability for each orthography to the pseudo corpus 340. The probability may indicate the possibility or likelihood that the variation or orthography of the listing would be input by a user.

In embodiments of the present invention, instead of explicitly creating a pseudo-corpus 340, the distortion module 310 may output the orthographies and/or associated probabilities directly to the parameter estimator 350 for processing.

In embodiments of the present invention, the parameter estimator 350 may employ conventional parameter estimation techniques such as counting word or N-Gram frequencies to generate a stochastic language model for the application that covers all the listings in the database 220. It is recognized that parameter estimator 350 may apply any conventional technique to generate the stochastic language model for the application that covers all the listings in the database 220.

In embodiment of the present invention, the distortion module 310 may process each listing in the database 220 to create orthographies or a set of possible word sequences (e.g., variations of word sequences) that may be uttered or input by the user. Each word sequence variation may include an associated probability indicator (prob.) that may specify the probability that this word sequence is to be input or uttered by the user who desires, for example, directory assistance for the listing.

In embodiments of the present invention, for example, the database 220 may include the listing “Creative Nails by Danny.” The distortion module 310 may produce the following orthographies with the associated probabilities:
Creative Nails by Danny; prob.=0.5
Danny Nails; prob.=0.2
Nails by Danny; prob.=0.2
Creative Nails; prob.=0.1

The probability (prob.) the distortion module 310 may assigns to each orthography may be a conditional probability of an orthography produced by the user given that a specific listing is the one that the user seeks. Thus, for example, the probability that the user will say “Danny nails” when requesting for the listing “Creative Nails by Danny” may be determined to be 0.2 or 20%. As indicated above, the orthographies and associated probabilities may be sent to a pseudo corpus 340 and/or may be sent directly to the parameter estimator 350 for processing.

In embodiments of the present invention, prior or historical probabilities may be applied to generate the probability (e.g., prob.) associated with each orthography. This can be done either within the distortion module, or later at the parameter estimation step. In the example above, the probabilities for all orthographies for “Creative Nails by Danny” sum up to 100%. The prior probability may be based on, for example, exiting prior knowledge that this listing is requested only 0.01% of all listing requests. Accordingly, using this prior probability, for example, the probabilities above should be multiplied by 0.0001 to reflect this prior knowledge.

In another example, the prior probability may be generated based on the manner the listing may have been referred to and/or been input in the past by users. When prior knowledge is taken into account, the sum of all probabilities for all orthographies for all listings should be 100%. It is understood the above described ways of generating probabilities are given by way of example only and that other techniques may be used to generate the probability associated with each listing orthography.

In accordance with embodiments of the present invention, the grammar generator 230 can periodically update the underlying grammar database 120 so that accurate results can be obtained from the automated information communication system 100.

Although the above description with reference to FIG. 3 is described with specific reference to the grammar generator 230 and grammar 120, it is recognized that the index generator 240 may operate similarly to update the index database, in accordance with embodiments of the present invention. For example, the index generator 240 may include distortion module 310, pseudo corpus 340 and/or parameter estimator 350, in accordance with embodiments of the present invention.

Embodiments of the present invention provide an automated communication information system where the grammar and/or index databases may be dependent on the underlying database. For example, in a residential listing case, the most frequent 100,000 names can be recomputed when the listing database is updated. Advantageously, this can result in better information coverage and more accurate results by the automated system.

Embodiments of the present invention may find application in a variety of different recognizers such as speech recognizers that use phonetics and/or stochastic language models. In case of a phonetic recognizer, the statistics used in the phonetic grammar may not represent general English language, but rather only the relevant utterances dependent on the current content of the database. Another, very important example is using stochastic grammars (like n-grams) that are based on the statistics of words, sub-words and sequences of words extracted from the current database content.

In embodiments of the present invention, the grammars and the index database 140 associated with the database search engine may be updated when the content of the database changes.

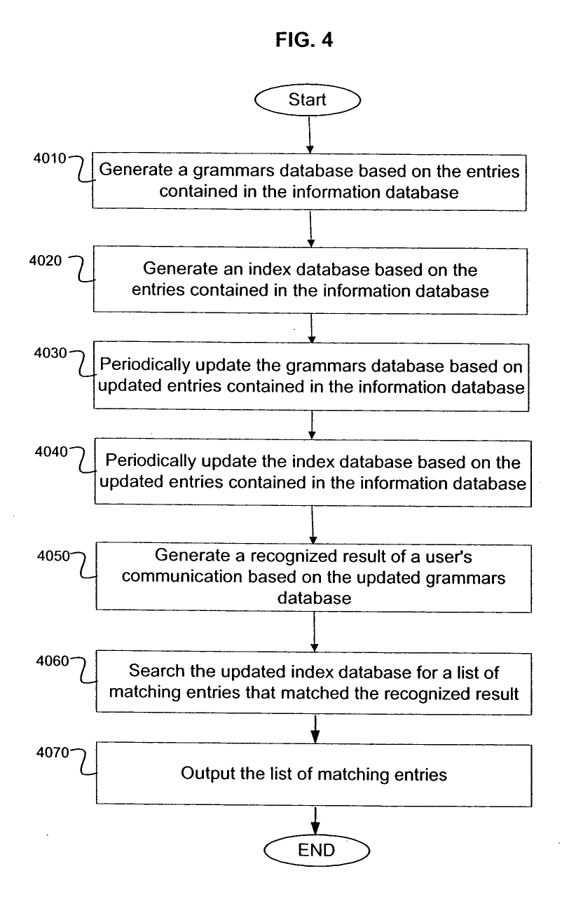

FIG. 4 is a flow chart in accordance with an embodiment of the present invention. As shown in 4010, a grammars database may be generated based on entries contained in an information database. In embodiments of the present invention, the entries in the grammars database may be a compact representation of the entries in the information database. For example, the entries in the grammars database may not directly correspond to entries in the listings database. An index database may be generated based on the entries contained in the information database, as shown in 4020.

In embodiments of the present invention, the grammars database may be periodically updated based on updated entries contained in the information database, as shown in 4030. As shown in 4040, the index database may be periodically updated based on the updated entries contained in the information database. A recognized result of a user's communication may be generated based on the updated grammars database, as shown in 4050.

In embodiments of the present invention, the updated index database may be searched for a list of matching entries that matched the recognized result, as shown in 4060. Additionally or optionally, the listings database may be searched for a list of matching entries that matched the recognized result using the updated index database.

As shown in 4070, the list of matching entries may be output. In one example, the list of matching entries may be output to a user for confirmation via an output manager. Alternatively, the list of matching entries may be used to retrieve a record ID or the like. The record ID, for example, may be used to look up information or entry in an information or listings database. That information may be presented to a user.

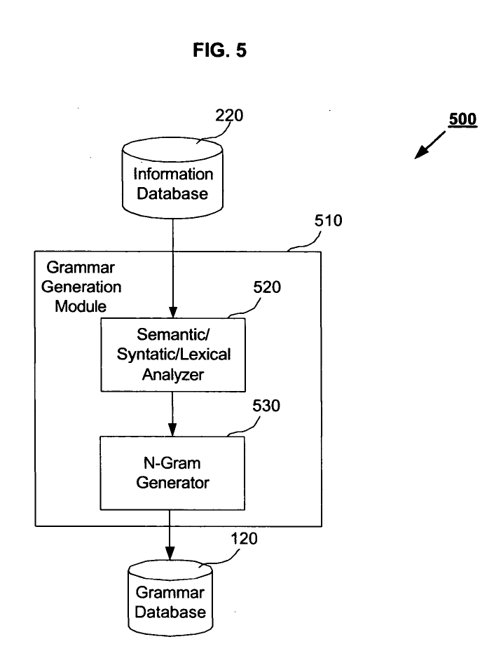

FIG. 5 is a detailed block diagram of grammar generator 500 in accordance with embodiments of the present invention. In accordance with an embodiment of the present invention, the entries in listings database 220, for example, may be input to and processed by a grammar generation module 510. The grammar generation module 510 may generate N-gram grammars that contain word N-grams that can be encountered in the different ways an entry in the listings database 220 may be input or pronounced by a user. The output of the grammar generation module 510 may be used to populate grammar database 120. Accordingly, the grammars of database 120 may be dynamically generated and/or updated in accordance with embodiments of the present invention.

In embodiments of the present invention, the grammar generation module 510 may process each listing of database 220 through a semantic/syntactic/lexical analyzer 520. The analyzer 520 may analyze the listing name and generate a transformation set that specifies the possible transformation rules to apply to the listing name, as described above with respect to analyzer 320. The rules may also specify that a word's form may change. For example, a rule may state that an entry such as “Tony's Pizzeria” may be represented as “Tony Pizza” or “Tony Pizzeria.” In other words the possessive “Tony's” may be changed to a different form such as the non-possessive “Tony.” Moreover, various rules may be combined. For example, the word's form may be changed as well as a substitution of a word may occur, as described above. For example, a rule may also state that the word “pizzeria” may be substituted with a word “pizza,” as provided in this example above. It is recognized that in some cases a word's form may be maintained. In other words, if the entry contains a possessive such as “Tony's,” the rules may retain this form and not change it to the non-possessive. The rules contained in the analyzer 520 may also determine the probability for each type of distortion. It is recognized that other rules that may preserve grammar usage or even change grammar usage may be output by the analyzer 520.

It is recognized that the transformation rules described above are given by way of example only, and any number of different types of transformation rules may be used by analyzer 520. In accordance with embodiments of the present invention, these transformation rules may indicate how a listing may be altered and/or distorted. As indicated above, this altered or distorted listing may indicate how users may alter the listing when requesting information such as directory assistance.

In embodiments of the present invention, the N-gram generator 530 may generate N-grams which may include, for example, possible word sequences that relate to listings or entries included in the information database 220.

In embodiments of the present invention, the grammar generation module 510 may output the possible N-grams generated by the N-gram generator 530 and the associated probabilities. The N-grams generator 530 may apply one or more transformation rules to generate the output N-grams. The associated probability may indicate the possibility or likelihood that the word sequence presented by the N-gram would be input by a user. The probability may be associated with each N-gram generated or a group of N-grams generated.

In embodiments of the present invention, the contents of information database 220 may be periodically processed using the grammar generation module 510 to generate N-gram grammars for grammars database 120, in accordance with embodiments of the present invention.

In embodiment of the present invention, the grammar generation module 510 may process each listing in the information database 220 to create orthographies or a set of possible word sequences (e.g., variations of word sequences) that may be uttered or input by the user. Each word sequence variation may include an associated probability indicator (prob.) that may specify the probability that this word sequence is to be input or uttered by the user who desires, for example, directory assistance for the listing.

As stated above, the above list may be a partial N-gram list and the N-gram generator 530 may create additional N-grams to be included in the above list. It is further recognized that N=2 is given by way of example only and that N can be any integer such as 3, 4, 5, etc. Thus, N-gram generator 530 may be tri-gram generator (e.g., N=3), a four-gram generator (e.g., N=4), a five gram generator (e.g., N=5) etc.

In embodiments of the present invention, the N-gram generator 530 may only generate a subset of N-grams. In other words, for a given listing that contains, for example, four (4) words, a N-gram subset generator may only generate 12 N-grams out of a possible 20 total N-grams. The subset of 12 N-grams may be generated based on a higher associated probability score and/or based on other reasons, for instance, linguistic reasons. In another example, assume that for a listing “midtown florist and greenhouse” two transformation rules can be applied to generate transformed word N-grams. Examples of transformation rules word omission rules, inversion rules, etc. The word omission rule may include an associated probability of omission (pₒₘ) which may indicate a certain probability with which a word can be skipped. The inversion rule may include a probability of inversion (pᵢₙᵥ) that may specify the probability by which order of words can change depending on certain circumstances. For example, the inversion rule may indicate that every two words can change the order in which they appear with another certain probability (pᵢₙᵥ). The inversion rule may usually be applied when the listing to be transformed contains words such as “and”, “by”, “of” etc.

Using conventional approaches, for a given listing, all distorted forms are generated, corresponding probabilities are computed and, for example, all bi-grams along with corresponding bi-gram probabilities are computed, as described above. Implementing this approach for a listing that contains four (4) words, for example, may need to generate up to 64 distorted forms. If the listing contains 15 words one of which is “and,” the total number of all distorted forms generated only with inversion is 15! (i.e., 15 factorial), which is over 10¹². Generating and processing such a huge set of distorted forms for just one listing may be unpractical or inefficient.

In contrast, the techniques described herein, in accordance with embodiments of the present invention, can avoid the generation of distorted forms which can be inefficient, unpractical or even impossible. According to embodiments of the present invention, only a set of N-grams that can be found in all the distorted forms of a particular listing may be generated. The probabilities of these N-grams may be evaluated directly based on the probabilities of the distortions applicable to this listing.

For a given listing such as the one in this example (i.e., “midtown florist and greenhouse”), a set of word N-grams may be generated along with a corresponding probability for each word N-gram. This set may be a total set of all N-grams that can be found in the distorted forms, or alternatively it can be a subset of the total set of N-grams. The probability associated with every N-gram may indicate the possibility or likelihood that the word N-gram would be input by the user when requesting for information associated with the listing. The generated word N-grams can be found in the entire set of distorted forms that can be generated for the listing. In accordance with embodiments of the invention, the generation of the entire set of distorted forms can be avoided. Embodiments of the present invention result in a more efficient and robust processing system for an automatic spoken language interface.

In embodiments of the present invention, each listing in, for example, an information database may be processed to generate a plurality of N-grams associated with the listing. For each entry or listing in the information database, a start indicator or word and an end indicator or word may be added to complete the listing. The start indicator may be represented by a symbol such as <S> at position 0, and end indicator may be represented by a symbol such as <E> after the last word in the listing (e.g., at position 5). Accordingly, the listing may be represented as “<S> midtown florist and greenhouse <E>” containing 6 words. In some cases, the transformation rules may not be applicable to the start and end indicators. In other words, for example, the start and/or end indicators may not be omissible and/or invertible. In which case, a distorted form can only start with the start indicator <S> and only end with end indicator <E>.

In accordance with embodiments of the present invention, the total set of bi-grams for the listing “<S> midtown florist and greenhouse <E>” may be, for example:

Bi-Grams(“midtown florist and greenhouse”) = {“<S> midtown”,
“<S> florist”, “<S> and”, “<S> greenhouse”, “midtown florist”,
“midtown and”, “midtown greenhouse”, “midtown <E>”, “florist
midtown”, “florist and”, “florist greenhouse”, “florist <E>”, “and
midtown”, “and florist”, “and greenhouse”, “and <E>”, “greenhouse
midtown”, “greenhouse florist”, “greenhouse and”, “greenhouse
<E>”}.

In accordance with embodiments of the present invention, the grammar generation module 510 may generate only a set of bi-grams that can be found in the distorted forms instead of the distorted forms. In this example, the grammar generation module 510 may generate a subset of the total set of twenty (20) entries listed above. The generated subset of N-gram may be equal to the total set of N-grams or it may be a proper subset of this set. These 20 entries may be all of the word bi-grams that can be generated based on a single listing such as “<S>midtown florist and greenhouse <E>.” Of course, a listing with fewer words will have fewer entries in the subset such as a bi-gram subset while a listing with more words will have more entries in the subset.

In embodiments of the present invention, the probability associated with an N-gram such as a bi-gram (w(I₁), w(I₂)), where I₁, I₂ are the word positions in the listing, can be modeled based on the following approach. The formula for the probability of, for example, a bi-gram may include factors such as a normalizing constant C, computed at the end so that the total sum of all probabilities are equal to 1, an omission part (OM), an inversion part (INV) and a validity part (VAL).

In embodiments of the present invention, the probability for a bi-gram may be determined based on the following formula:
Prob(w(I₁), w(I₂))=Prob(I₁,I₂)=C*OM(I₁,I₂)*INV(I₁,I₂)*VAL(w(I₁), w(I₂))

In embodiments of the present invention, the omission part OM may reflect the probability that words between positions I₁ and I₂ may be omitted by the user when making a request for a listing. The formula for calculating the omission part (OM) may be OM(I₁,I₂)=pₒₘ^{Z}, where z=abs(I₁−I₂)−1, I₁≠I₂, is non-negative and equal to the number of words that were omitted when the user uttered the word w(I₂) after the word w(I₁).

In embodiments of the present invention, if I₁ and I₂ represent adjacent positions (i.e., meaning that no words in between have been omitted), then this factor OM(I₁,I₂) is equal to 1 (e.g., OM(0,1)=OM(1,0)=OM(3,2)=1). Otherwise, the value of OM may be computed based on how many word positions there are between I and J. For example, if I₁ represents the third position of a word in the listing (I₁=3) and I₂ represents the sixth position of a word (I₂=6), then there are two positions skipped between I₁ and I₂ (abs(I₁−I₂)−1=2 ) resulting in OM(I₁,I₂)=OM(3,6)=pₒₘ². Then based on the value of the probability of omission pₒₘ, the omission part OM may be calculated, in accordance with embodiments of the present invention. The value of omission probability pₒₘ may be set up following a variety of approaches. One approach would be to set pₒₘ to the same value for all entries, e.g., pₒₘ=0.5 or pₒₘ=0.7. Another approach would be to set pₒₘ to a value that is a function of the number of words in a given entry: pₒₘ=F(length(entry)), so that a word omission in a longer entry (e.g. consisting of 10 words) is more probable, than in a shorter entry (e.g. consisting of 2 words). In another approach, the omission probability pₒₘ can be evaluated based on a transcribed corpus of users' utterances. The implementations of this approach may have the same estimated from corpus omission probability for all entries; otherwise the estimated omission probability may be a function of an entry length. In other implementations, pₒₘ may depend on a word, e.g., the omission probability for word “incorporated” may be much higher, for instance, pom(“incorporated”)=0.9, than the omission probability for word “mcdonalds”, for instance, pₒₘ(“mcdonalds”)=0.01.

In embodiments of the present invention the inversion, part INV(I₁, I₂) may indicate the probability that the words, for example, represented by I₁, I₂ for a bi-gram are not inverted (e.i., ordered in the bi-gram in the same way as in the listing, I₁<I₂) or are inverted (e.i., ordered in the bi-gram in the opposite way as in the listing, I₁ >I₂). The inversion part INV(I₁, I₂) may be defined differently for invertible positions (e.g., where I₁>0 and I₂ less than the position of the end indicator <E>), and non-invertible positions. The non-invertible positions are positions that may not be reversible with another word and include, for example, the start indicator <S> (e.g., at position 0) and/or the end indicator <E> (e.g., at the last position). For non-invertible positions, if I₁<I₂, INV(I₁, I₂)=1, and if I₁, I₂, INV(I₁, I₂)=0. For invertible positions, if I₁<I₂, IINV(I₁, I₂)=(1−pᵢₙᵥ), (no inversion) and if I₁>I₂, INV(I₁, I₂)=pᵢₙᵥ (inversion). The value of the inversion probability pᵢₙᵥ may be set up following a variety of approaches. One approach would be to set pᵢₙᵥ to the same value for all entries, e.g., pᵢₙᵥ=0.5 (inversion and non-inversion are equally probable) or pₒₘ=0.2 (inversion is 4 times less likely than non-inversion), or pᵢₙᵥ may be set to some other value pᵢₙᵥ=constant.

In another approach, all words can be split into word classes, with the function class=Class(w) mapping a word to a class number, so that pᵢₙᵥ would be to set to a value pᵢₙᵥ=f(Class(w(I₁)), Class(w(I₂)), I₁, I₂, wᵢₙᵥₑᵣₜₑᵣ) that is a function of the classes that contain the words from the word pair under question, of the word positions I₁, I₂, and of the word wᵢₙᵥₑᵣₜₑᵣ that indicates that inversion is possible for this listing. The above approaches can be enhanced by using transcribed corpus.

In embodiments of the present invention, the validity part VAL may indicate whether the particular word bi-gram is valid. In some cases, the validity part VAL may depend on the sophistication and/or sensitivity of the N-gram generation module 530. In other words, if the module 530 can detect that some word bi-grams, tri-grams, etc. are impossible or extremely unlikely to appear in a distorted form, the validity part value may be set to zero (0) for those bi-grams, tri-grams, etc. For example, if the N-gram generation module 530 can determine that the word “and” is hardly ever at the end or at the beginning of the listing, the validity part for the corresponding bigrams “and <E>” and “<S>and” may be set to zero (0) (VAL(“and <E>”)=VAL(“<S> and”)=0). Otherwise, for the bi-grams that cannot be automatically ruled out based on such predetermined rule, value for the VAL component is set to one (1). If, however, the analyzer does not have this validity detection capability, the validity part value for all bi-grams may be set to one (1). In embodiments of the present invention, the validity part VAL may be used to eliminate from consideration bi-grams or the like that are extremely unlikely to appear in a distorted form.

In embodiments of the present invention, the normalizing constant C may be computed based on the following C=1/(ΣOM(I₁, I₂)*INV(I₁, I₂)*VAL(w(I₁), w(I₂)). As indicated above, C may be computed at the end of the process after all other components of the probabilities for all N-grams are calculated so that the total sum of all N-gram probabilities can be equal to one (1).

Below are some sample probability values for a few bi-grams based on the omission probability pₒₘ=0.4 and inversion probability pᵢₙᵥ=0.2. Accordingly Prob(0, 4)=Prob(“<S> greenhouse”)=C*OM(0,4)*INV(0,4)=C*0.4³*1=C*0.064. The Prob(2,3)=Prob(“florist and”)=C*OM(2,3)*INV(2,3)=C*1*0.8=C*0.8. The Prob(3,2)=Prob(“and florist”)=C*OM(3,2)*INV(3,2)=C*1*0.2=C*0.2.

In embodiments of the invention, the value(s) for all or some OM(I₁, I₂) and/or INV(I₁, I₂) can be preset to one (1). Moreover, in the above formula Prob(w(I₁), w(I₂))=Prob(I₁,I₂) it was implicitly assumed that there is one-to-one mapping of words in the listing name to the positions. This may be true when every unique word appears in the listing name only once as in the above example. In a general case when words can appear in the listing name more than once, probabilities of position-bigrams may be evaluated first according to the formula Prob(I₁, I₂)=C*OM(I₁, I₂)*INV(I₁, I₂)*VAL(w(I₁), w(I₂)). After that the probabilities of word-bigrams (u, v) may be computed as follows:

$$Prob ( u , v ) = {\sum }_{( K , L ) : {w}_{K} = u , {w}_{L} = v} Prob ( K , L ) .$$

Thus, in embodiments of the present invention, word N-grams that exist for more than one combination of positions in one entry in an information database may be identified as duplicate-within-entry word N-grams. The associated probability of the identified duplicate-within-entry word N-grams may be accumulated. Moreover, the same word N-gram may be present in N-gram sets for several database entries, so that an N-gram may be duplicate across entries. The duplicate-across-entries word N-grams and the corresponding accumulated probability score may be stored and used for generating possible matches for user requests.

It is recognizes that although the probability values for bi-grams have be described above, embodiments of the present invention can be applied to tri-grams, four-grams, five-grams, etc. For example, in the case of tri-grams, the base formula for probability may be Prob(I₁,I₂,I₃)=C*OM(I₁,I₂,I₃)*INV(I₁,I₂,I₃)*VAL(w(I₁),w(I₂),w(I₃)),. Thus, in order to compute OM(I₁,I₂,I₃), a variation of the position values may be presented in ascending order as I′. For instance if I₁=4,I₂=1,I₃=3 the sequence (4, 1, 3) may be transformed into (1, 3, 4), so that I₁=1′,I₂=3′,I₃=3′. Then it may be assumed OM(I₁,I₂,I₃)=OM(I₁′, I₂′, I₃′)=pₒₘ^{J′-I′-1}. pₒₘ^{K′-J′-1}, where I′=I₁′, J′=I₂′, K′=I₃′, and INV(I₁,I₂,I₃)=INV(I₁,I₂)*INV(I₂,I₃). As for VAL(w(I₁),w(I₂),w(I₃), it may depend on the sophistication of the distortion module 520. For example, if the module 520 can detect that the word sequence w(I₁),w(I₂),w(I₃), is impossible or very unlikely to appear in a user input, VAL may be set it 0, otherwise VAL may be set to 1. Moreover, just as for bi-grams stated above, for a particular case, one or more of the OM(I₁,I₂,I₃) and/or INV(I₁,I₂,I₃) can be pre-set to the value of one (1).

In embodiments of the present invention, the N-gram probabilities can be calculated if the distortions include, for example, omission and/or inversion. Accordingly, instead of 64 distorted forms for a listing with 4 word entries (or 6 if we include start and end symbols), only 20 bi-grams may be generated, in accordance with embodiments of the present invention. In the event of a listing that includes many more word entries such as 15 words, where at least one entry is “and,” the entire set of all distorted forms can be over 15! (15 Factorial). This results in more than 10¹² distorted forms in the entire set. Generation of such a large set of distorted entries may be difficult, impractical , and/or at the very least, a time and memory consuming task. According to the current invention, generating all distorted forms may be avoided since only 15*14 (both components are real words out of the 15 contained in the listing)+15 (the first component is start symbol <S>, the second is one of the 15 words)+15 (the first component is one of the 15 words, the second is end symbol <E>)=240 bi-grams and their probabilities may need to be generated for a listing that has 15 word entries. If we assume that generating one bi-gram and the corresponding probability takes 100 times more time than generating one distorted form, then generating all 240 bi-grams and corresponding probabilities will be 10¹²/(240*100)=40*10⁶ faster than generating all 10¹² distorted forms.

In embodiments of the present invention, other distortions might need different formulas. Some distortions that do not result in combinatorial growth of the number of distorted forms, can be applied to generate explicitly distorted forms. For example, a word-synonym rule that allows a substitute word “pizza” for word “pizzeria”, or “restaurant” for word “cafe” may be applied. In embodiments of the present invention, in case of omission and/or inversion and some other distortions instead of generating distorted forms, n-grams may be generated directly and the corresponding probabilities evaluated.

The probability the grammar generation module 510 may assign to each N-gram may be a conditional probability that this N-gram is a part of an orthography produced by the user given that a specific listing is the one that the user seeks. Thus, for example, the probability that the user will say “Danny nails” as a part of his utterance when requesting the listing “Creative Nails by Danny” may be determined to be 0.2 or 20%. As indicated above, the N-grams and associated probabilities may be sent to grammar database 120, in accordance with embodiments of the present invention.

In embodiments of the present invention, prior or historical probabilities may be applied to generate the probability (e.g., prob.) associated with each bi-gram. The prior probability may be based on, for example, existing prior knowledge that this listing is requested only 0.01% of all listing requests. Accordingly, using this prior probability, for example, the probabilities above should be multiplied by 0.0001 to reflect this prior knowledge.

In accordance with embodiments of the present invention, the grammar generation module 510 can periodically update the underlying grammar database 120 so that accurate results can be obtained from the automated information communication system 100.

Although the above description with reference to FIG. 5 is described with specific reference to the grammar generation module 510 and grammar database 120, it is recognized that this method may also be applied to the index generator 240 to update the index database 140, in accordance with embodiments of the present invention. For example, the index generator 240 may include grammar generation module 510 that may generate outputs to populate database 240, in accordance with embodiments of the present invention.

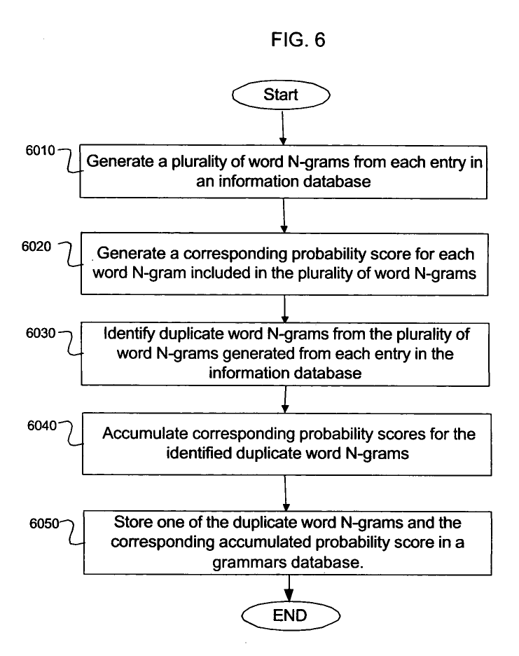

FIG. 6 is a flow chart illustrating a method for providing a spoken language interface to an information database, in accordance with an embodiment of the present invention. As shown in 6010, a plurality of word N-grams from each entry in an information database may be generated. These may be, for example, word bi-grams, word tri-grams, word four-grams, etc. A corresponding probability score for each word N-gram included in the plurality of word N-grams may be generated, as shown in box 6020.

In embodiments of the invention, any one word N-gram from the plurality of word N-grams is included in a distorted version of the entry generated based on a transformation rule. The distorted version of the entries in the database may include all possible distortions for the entry making such a list sometimes very large and difficult to process in a time efficient manner. Embodiments of the present invention may generate a subset list that is smaller list of distortions. Depending on system configurations, such a subset list may include, for example, only word bi-grams or tri-grams that may represent how a user may request the listing. As described above, a corresponding probability score corresponding to each bi-gram, for example, may be generated.

As shown in box 6030, duplicate word N-grams from the plurality of word N-grams generated from each entry in the information database may be identified. These duplicate word N-grams may be those word N-grams that appear in more than one entry in the information database. The corresponding probability scores for the identified duplicate word N-grams may be accumulated, as shown in box 6040. As shown in box 6050, one of the duplicate word N-grams and the corresponding accumulated probability score may be stored in a grammars database.

It is recognized that the device and/or systems incorporating embodiments of the invention may include one or more processors, one or more memories, one or more ASICs, one or more displays, communication interfaces, and/or any other components as desired and/or needed to achieve embodiments of the invention described herein and/or the modifications that may be made by one skilled in the art. It is recognized that a programmer and/or engineer skilled in the art to obtain the advantages and/or functionality of the present invention may develop suitable software programs and/or hardware components/devices. Embodiments of the present invention can be employed in known and/or new Internet search engines, for example, to search the World Wide Web.

Several embodiments of the present invention are specifically illustrated and/or described herein. However, it will be appreciated that modifications and variations of the present invention are covered by the above teachings and within the purview of the appended claims without departing from the spirit and intended scope of the invention.

1. A method for providing a spoken language interface to an information database, comprising:
generating a plurality of word N-grams from each entry in the information database and a corresponding probability score for each word N-gram included in the plurality of word N-grams, and wherein any one word N-gram from the plurality of word N-grams is included in a distorted version of the entry generated based on one or more transformation rules;
identifying duplicate word N-grams from the plurality of word N-grams generated from each entry in the information database;
accumulating corresponding probability scores for the identified duplicate word N-grams; and
storing one of the duplicate word N-grams and the corresponding accumulated probability score in a grammars database.

2. The method of claim 1, wherein the word N-grams are word bi-grams.

3. The method of claim 2, wherein the word N-grams are word tri-grams.

4. The method of claim 1, wherein one or more of the plurality of word N-grams are generated by applying the transformation rule to one or more entries in the information database.

5. The method of claim 1, wherein the transformation rule is a word omission rule which indicates that one or more words of the one or more entries in the information database can be skipped.

6. The method of claim 1, wherein the transformation rule is a word inversion rule which indicates that one or more words of the one or more entries in the information database can be inverted.

7. The method of claim 1, wherein the one or more transformation rules include both a word omission rule and a word inversion rule.

8. The method of claim 7, wherein the one or more transformation rules include a rule that does not result in combinatorial growth of number of distorted forms.

9. The method of claim 1, wherein the information database is a listings database.

10. The method of claim 1, wherein the grammars database is updated daily, weekly or monthly.

11. The method of claim 1, furthering comprising:
inserting a start indicator before a first word of the entry; and
inserting an end indicator after a last word of the entry.

12. The method of claim 1, wherein the corresponding probability score for each word N-gram included in the plurality of word N-grams for a given entry is calculated using the formula: Prob(I₁, I₂, . . . , I_{N})=C*OM(I₁, 1₂, . . . , I_{N})*INV(I₁, I₂, . . . , I_{N})*VAL(w(I₁), w(I₂), . . . w(I_{N})), where I₁, I₂, . . . , I_{N} represent positions of words in the entry that compose the word N-gram, C represents a normalizing constant, OM represents an omission part probability, INV represents an inversion part and VAL represents a validity part probability.

13. A method for processing a user's request for information, comprising:
generating a plurality of word N-grams from each entry in the information database and a corresponding probability score for each word N-gram included in the plurality of word N-grams, and wherein any one word N-gram from the plurality of word N-grams is included in a distorted version of the entry generated based on a transformation rule;
identifying duplicate word N-grams from the plurality of word N-grams generated from each entry in the information database;
accumulating corresponding probability scores for the identified duplicate word N-grams;
storing one of the duplicate word N-grams and the corresponding accumulated probability score in a grammars database;
receiving the user's request for information;
recognizing the user's request against the word N-grams stored in the grammars database;
matching the recognized user's request with one or more entries from information database;
selecting the matched entries from the information database with corresponding confidence levels that meet or exceed a threshold.

14. The method of claim 13, further comprising:
forwarding information associated with the selected entry with highest confidence level to a user.

15. The method of claim 13, further comprising:
forwarding information associated with the selected entries to a user for confirmation.

16. The method of claim 13, wherein the information database is a directory listings database and the request for information is a request for a telephone number, the method further comprising:
forwarding a number associated with the selected entry to a user.

17. Apparatus comprising:
an information database to store a plurality of information entries;
a processor configured to:
generate a plurality of word N-grams from each entry in the information database and a corresponding probability score for each word N-gram included in the plurality of word N-grams, and wherein any one word N-gram from the plurality of word N-grams is included in a distorted version of the entry generated based on a transformation rule,
identify duplicate word N-grams from the plurality of word N-grams generated from each entry in the information database, and
accumulate corresponding probability scores for the identified duplicate word N-grams; and
a grammars data base to store one of the duplicate word N-grams and the corresponding accumulated probability score.

18. The apparatus of claim 17, further comprising:
a recognizer to recognize the user's request against the word N-grams stored in the grammars database and wherein the processor further configured to:
match the recognized user's request with one or more word N-grams stored in the grammars database and
select an entry from the information database associated with a matching N-gram, if the match has a corresponding confidence level that meets or exceeds a threshold.

19. The apparatus of claim 17, further comprising:
an output manager to forward information associated with the selected entry with highest confidence level to a user.

20. The apparatus of claim 17, further comprising:
an output manager to forward information associated with the selected entries to a user for confirmation.

21. A machine-readable medium having stored thereon a plurality of executable instructions to be executed by a processor to implement a method for providing a spoken language interface to an information database, the method comprising:
generating a plurality of word N-grams from each entry in the information database and a corresponding probability score for each word N-gram included in the plurality of word N-grams, and wherein any one word N-gram from the plurality of word N-grams is included in a distorted version of the entry generated based on a transformation rule;
identifying duplicate word N-grams from the plurality of word N-grams generated from each entry in the information database;
accumulating corresponding probability scores for the identified duplicate word N-grams; and
storing one of the duplicate word N-grams and the corresponding accumulated probability score in a grammars database.

22. The machine-readable medium of claim 21, the method further comprising:
inserting a start indicator before a first word of the entry; and
inserting an end indicator after a last word of the entry.
